(19) United States
(12) Patent Application Publication
(10) Pub. No.: US 2014/0006069 A1
(43) Pub. Date: Jan. 2, 2014

(54) SYSTEMS AND METHODS FOR INTEGRATING GEOLOCATED SALES WITH SOCIAL MEDIA PLATFORMS

(71) Applicant: Chris Guggenheim, Austin, TX (US)

(72) Inventor: Chris Guggenheim, Austin, TX (US)

(21) Appl. No.: 13/538,633

(22) Filed: Jun. 29, 2012

(51) Int. Cl. G06Q 10/02

(52) U.S. Cl. 705/5

(57) ABSTRACT

Systems and methods for integrating geolocated sales with social media platforms may be provided wherein a widget may be embedded within a social media platform. A user of the social media platform may receive information about an event, activity or venue associated with his/her geographic location through a widget embedded within the social media platform. Upon receiving such information, the user may access a widget embedded within the social media platform and make a purchase associated with the event or activity. Such a geolocated sales purchase may be made without the user having to leave the social media platform. The widget also may provide a sharing functionality wherein the user may share information about his/her purchase on the social media platform.

### FIELD OF THE INVENTION

The present disclosure generally relates to online sales, and more particularly to integrating geolocated sales with social media platforms.

### BACKGROUND

In the past, a user desiring to purchase tickets online for an event may use a website associated with or generally offering tickets to the event to make such a purchase. A user may generally search for an event by specifying certain geographic parameters in order to identify an event in the desired location. Accordingly, the website for purchasing tickets may not include geolocation capabilities wherein ticket offers may be tailored to the individualized user. Further, once a user purchases a ticket, he/she may choose to log onto a social media platform, such as Facebook or Twitter, in order to notify friends that he/she is going to the event and perhaps encourage friends to also purchase tickets. However, the website where the ticket purchase is made operates separately from the social media platform.

### SUMMARY

Embodiments of the present disclosure may provide a computer-implemented method for integrating geolocated sales with a social media platform rendered in a web browser that may comprise interacting with a tickets database through a first communication link to look up an event, receiving a response over the first communication link from the tickets database providing the event, providing the event to a widget embedded within the social media platform or website that may be rendered in a web browser through a second communication link, receiving a purchase request corresponding to the event over the second communication link, sending a ticket reservation request to the tickets database over the first communication link, and submitting an order to an orders database over a third communication link. The method may further comprise receiving a message indicating ticket reservation success or failure in response to sending the ticket reservation request. The method also may comprise receiving a message indicating order submission success or failure in response to submitting the order to the orders database. The method may comprise transmitting an order confirmation to a customer upon receiving the message indicating order submission success or failure. The order confirmation may be transmitted to the customer via email. The method may also comprise communicating a message to the widget indicating purchase success or failure upon receiving the message indicating order success or failure. The web browser may comprise one of the following Internet Explorer, Firefox, Chrome, Safari and Safari Mobile. The first communication link, second communication link and the third communication link each may comprise one of the following: local area network (LAN), wide area network (WAN), wired Ethernet, wireless Ethernet, Internet, cellular connection, serial connection, parallel connection, and USB connection.

Other embodiments of the present disclosure may provide a widget embedded within a social media platform rendered in a web browser that may comprise a first section to display information about an event corresponding to a geographical location of a user of the social media platform wherein the widget is embedded, a second section to provide purchase options and a checkout function associated with the event, and a third section to provide confirmation of the purchase associated with the event. The first section, the second section, and third section may comprise a sharing button wherein the user may share the purchase with other users of the social media platform. Information about the event corresponding to the geographical location may comprise at least one of the following: an image corresponding to the event, an event title, an event location, an event date, and pricing information. The widget may further comprise a progress indicator, wherein the progress indicator may be located on one or more of the first section, the second section, and the third section. The second section also may comprise a map identifying seats available for the event. The second section may further comprise a ticket selector, wherein the map may provide seats corresponding to the number of tickets selected through the ticket selector. The second section also may comprise a package selector having a number selector and a type selector. Purchase options may comprise payment options and delivery method.

Further embodiments of the present disclosure may provide a system for integrating geolocated sales with a social media platform through a widget embedded in the social media platform that may comprise a web browser rendering the widget embedded in the social media platform, and an application programming interface (API) in communication with the web browser to provide an event to the widget, receive a purchase request from the widget, and confirm a purchase to the widget, wherein the event may correspond to the geographic location of a user using the social media platform. The system also may comprise a tickets database, wherein the API may interact with the tickets database to look up and receive the event to provide to the widget. The API also may interact with the tickets database to make a ticket reservation request and receive a message indicating ticket reservation success or failure. The system may further comprise an orders database, wherein the API may interact with the orders database to submit an order associated with the event.

### BRIEF DESCRIPTION OF THE DRAWINGS

For a more complete understanding of this disclosure, reference is now made to the following description, taken in conjunction with the accompanying drawings, in which:

FIG. 1 depicts a system and method of widget workflow according to an embodiment of the present disclosure;

FIG. 2A depicts a front view of a widget according to an embodiment of the present disclosure;

FIG. 2B depicts a back view of a widget according to an embodiment of the present disclosure;

FIG. 2C depicts another view of a widget according to an embodiment of the present disclosure;

FIG. 3A depicts a first view of a widget according to an embodiment of the present disclosure;

FIG. 3B depicts a second view of a widget according to an embodiment of the present disclosure;

FIG. 3C depicts a third view of a widget according to an embodiment of the present disclosure;

FIG. 3D depicts a fourth view of a widget according to an embodiment of the present disclosure;

FIG. 3E depicts a fifth view of a widget according to an embodiment of the present disclosure;

FIG. 3F depicts a sixth view of a widget according to an embodiment of the present disclosure; and

FIG. 3G depicts a seventh view of a widget according to an embodiment of the present disclosure.

### DETAILED DESCRIPTION

Embodiments of the present disclosure may provide a form of decentralized electronic commerce (also known as “e-commerce”) focusing on commerce sales through integration with social media platforms, including but not limited to Facebook and/or Twitter. Geolocation is becoming a key feature in entertainment and sports given the mobility of shows/competitions as well as the mobility of potential attendees or ticket purchasers. Embodiments of the present disclosure may provide a user with the ability to affiliate with an artist or event page, such as by “liking” a page on Facebook. Once a user has expressed interest in the artist or event, when he/she may access that Facebook page at another time, the user may be presented with information concerning upcoming events in the user's geographical location that may be appealing to the user. A user also may express interest in a certain venue, such as the Rose Bowl or the Fort Worth Zoo. This geolocation tool may be built directly into a social media platform, such as a Facebook page, to provide a widget for a user to purchase tickets or other forms of commerce that may be of specific interest to that user without ever having to exit the Facebook page.

For example, a user may live in Dallas, Tex., and express an interest in Willie Nelson by “liking” the Willie Nelson Facebook page. Facebook may have options for collecting information about the user's geographical location. Accordingly, if Willie Nelson's tour is passing through Dallas, Tex., the user may be presented with an option to purchase tickets to the Dallas, Tex. leg of the tour. In embodiments of the present disclosure, the user may elect to purchase tickets directly through a widget that may be embedded within the Willie Nelson Facebook page. Further, the widget may provide a user with an opportunity to purchase other commerce of interest to the user that may be related to Willie Nelson. Accordingly, embodiments of the present disclosure may give the provider of the Willie Nelson Facebook page the ability to use geolocation through social media to get the right product to the right user, and the user may elect to purchase commerce through the widget on the social media platform without ever having to exit the social media platform.

In other embodiments of the present disclosure, geolocation may occur through use of a user's Internet Protocol (IP) address. In further embodiments of the present disclosure, if a user is viewing the social media platform from his/her mobile device, geolocation may occur through use of the user's mobile GPS location. As such, a user may be provided with opportunities to make commerce purchases based on his/her location, and even be provided with a specific screen on a widget, without ever having to leave the social media platform. For example, Willie Nelson may be touring across the United States and may make a stop in Dallas, Tex. If the user's IP address or mobile GPS location shows that he/she is located in the Dallas area, then that user may provided with the option to buy tickets for the Dallas show or other Willie Nelson-related merchandise. The user also may be provided with an extra screen on the widget embedded within the Willie Nelson Facebook page that may give the user an exclusive download offer or another benefit from being identified by his/her IP address or mobile GPS location.

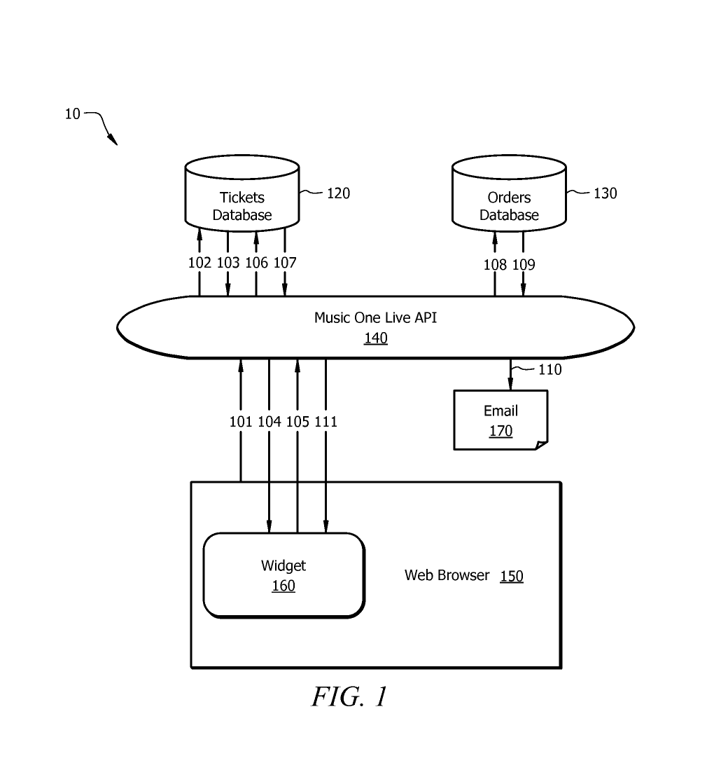

FIG. 1 depicts a system and method 10 for integrating geolocated sales with social media platforms according to an embodiment of the present disclosure. In step 101, web browser 150 may make an initial request to an API, such as Music One Live API 140, to load widget content to serve up information about an event and allow a user to make a purchase via a widget that may be embedded within a social media platform or a website that may be rendered within a web browser. Web browser 150 may include, but is not necessarily limited to, Internet Explorer, Firefox, Chrome, Safari and/or Safari Mobile. Other browsers or versions may be directed to a flash version of the widget if they are not supported.

In step 102, API 140 may interact with tickets database 120 to look up an event. It should be appreciated that “event” as referenced according to embodiments of the present disclosure may broadly include events as well as venues or other activities that may involve a purchase as will be later described. Similarly, when a “ticket” or “tickets” are referenced, it should be appreciated that commerce in addition to tickets may be purchased according to embodiments of the present disclosure. For example, while database 120 may be referred to as a tickets database, it should be appreciated that this database also may include information regarding merchandise or other commerce without departing from the present disclosure.

It should be appreciated that API 140 may support several functions, including making dynamic seating reservations, as will be described in more detail below. For example, API 140 may issue a call that may include information, including but not limited to a reference ID, an identification of the event, selection options, as well as the quantity of seats needed during the checkout process to create seat reservations. Upon issuance of this call, system 10 may check the availability of the selected option and quantity, reserve the seats according to the quantity specified and available, save the reference ID to identify the transaction once the purchase has been completed, and then return either an error with a human-readable description or an acceptance message. API 140 also may issue a call when the “payment completed” notification is received from a source, such as PayPal. After this call, the payment and the transaction may be completed.

Tickets database 120 may then respond to API 140 to provide the event in step 103. In step 104, API 140 may provide the event to widget 160 in web browser 150. Widget 160 may then return a purchase request to API 140 in step 105. In step 106, API 140 may make a ticket reservation request to tickets database 120, and tickets database 120 may return a message to API 140 indicating ticket reservation success or failure in step 107. In step 108, API 140 may submit the order to orders database 130, and in step 109, orders database 130 may return a message to API 140 indicating order submission success or failure. In step 110, API 140 may transmit an order confirmation to a customer, such as through email 170. In step 111, API 140 may communicate a message indicating purchase success or failure to widget 160.

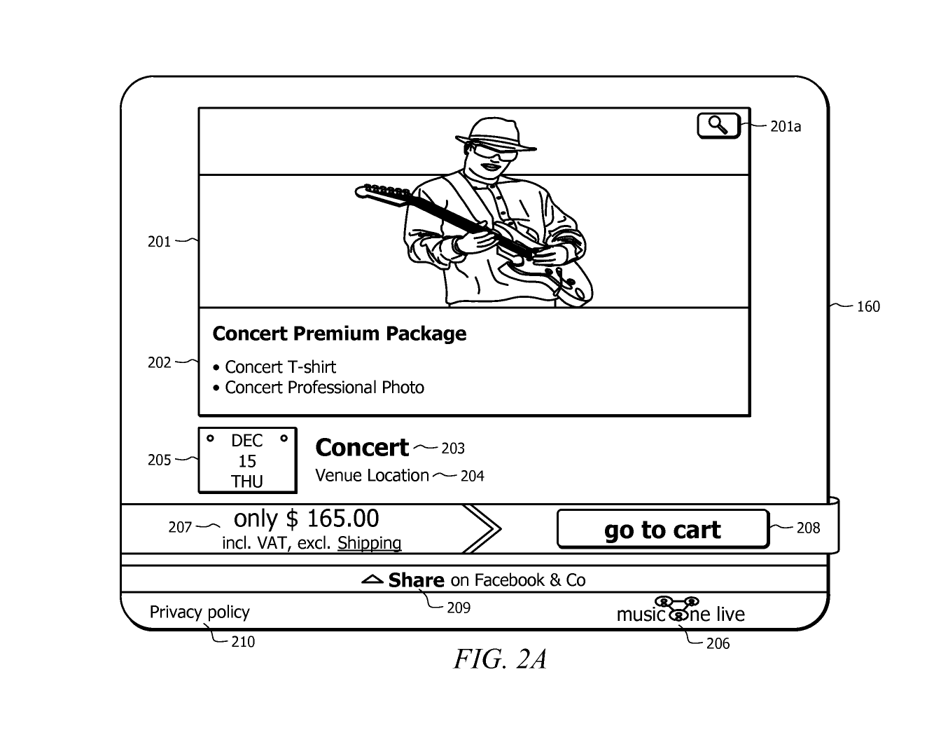

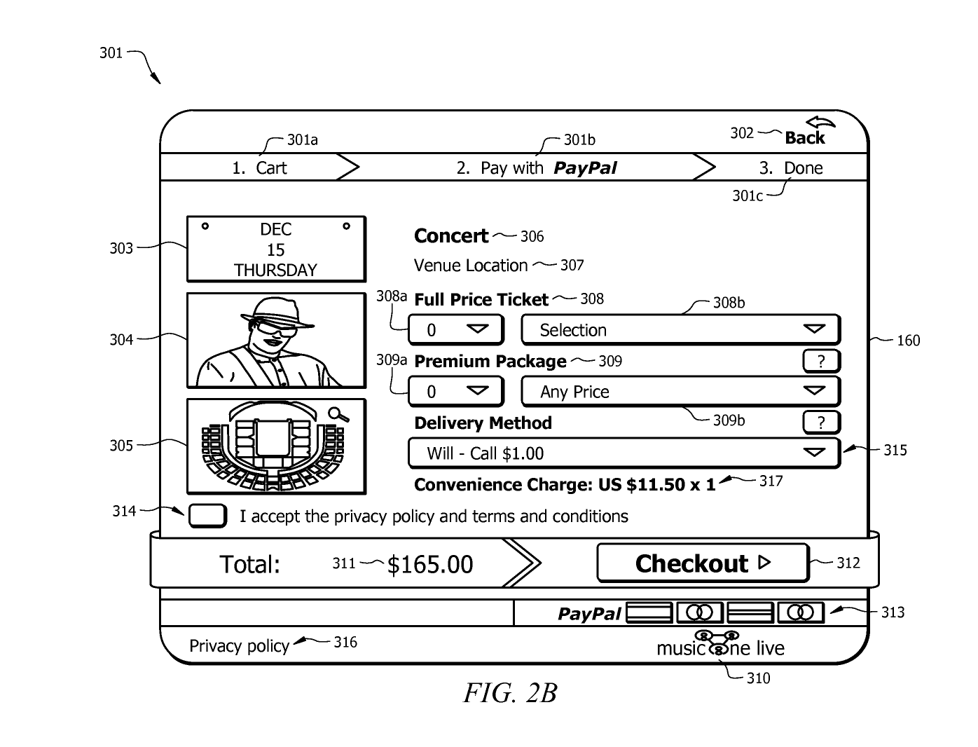

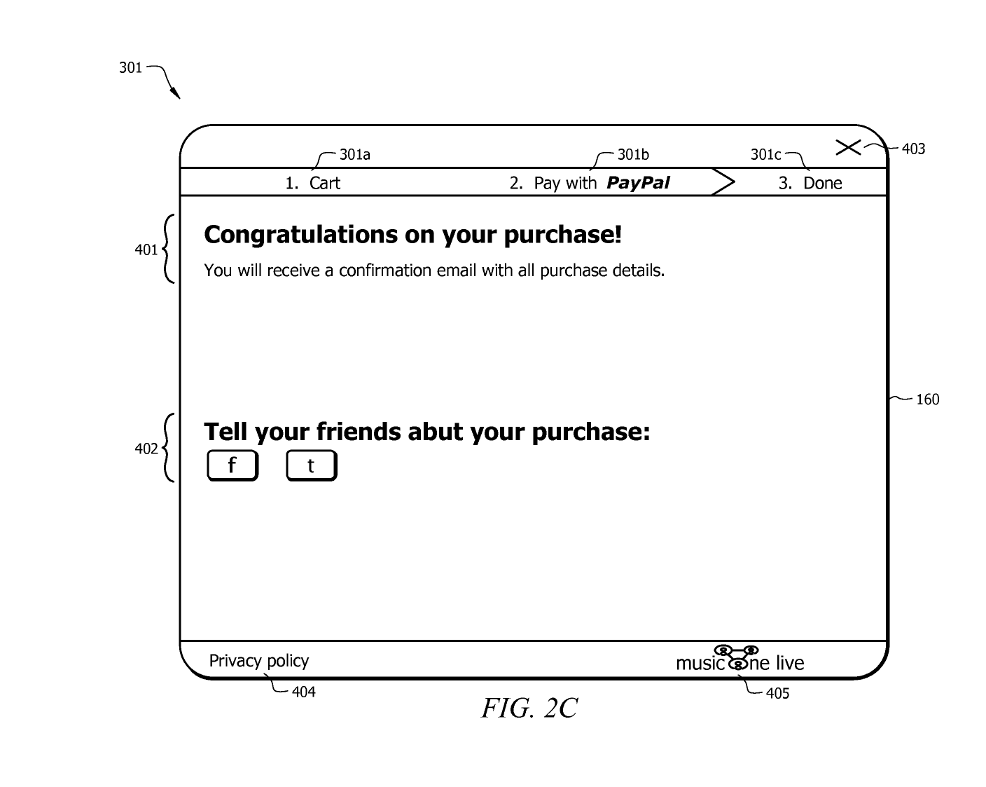

Embodiments of the present disclosure may provide a customizable widget, such as widget 160, that may allow purchase of tickets or other commerce related to various types of events or venues. It should be appreciated that any customizable data may be encapsulated in a JSON data field on the widget. However, other types of data fields may be used with respect to the widget without departing from the present disclosure. Widget 160 may have a front view (as depicted in FIG. 2A) that may display information about the event, venue or other commerce to be purchased as well as a back view (as depicted in FIG. 2B) that may provide purchase options and a checkout function. The checkout process may be connected to an API (such as API 140) to allow dynamic seat reservations.

FIG. 2A depicts a front view of widget 160 according to an embodiment of the present disclosure. The front view of widget 160 may include image 201. Image 201 may be a photograph or other image depicting some identifier with respect to the event, venue or commerce, such as to capture the attention of a user. Image 201 may provide an image associated with a tour. It also may provide an image associated with a featured event, activity, and/or article of commerce. In embodiments of the present disclosure, if the widget is embedded within a social media platform associated with a venue, it should be appreciated that image 201 may be an image of the venue itself and/or it may be an image associated with an artist scheduled to perform at the venue without departing from the present disclosure.

Image 201 also may include button 201a that may allow image 201 to be zoomed or otherwise enlarged according to the preferences of a user. The front view of widget 160 also may include event title 202, and this information may be derived from a custom JSON data field. Event title 202 may include bullet points also derived from a custom JSON data field to provide additional information about the event or package that may be purchased by a user. In this embodiment, the concert premium package may include a concert t-shirt as well as a concert professional photo. However, it should be appreciated that other items, such as greet tickets to the event or keepsake VIP laminates, may be included in a package offered through widget 160 without departing from the present disclosure. It also should be appreciated that widget 160 may include limitations on the maximum number of items listed as part of a package within event title 202. Further, there may be limitations set on the amount of information that may be included about each item listed within event title 202. It should be appreciated that widget 160 may limit the length of each item listed as bullet points within event title 202 or parameters may be set to provide that content exceeding certain limitations may not be visible to the user. However, it should be appreciated that limitations for information included within event title 202 may be customized on a widget-by-widget basis.

Widget 160 may include default widget name 203. Widget name 203 may include a sub-title such as event/venue location 204 as well as event date 205. Event/venue location 204 and event date 205 may be taken from custom JSON data fields. Event date 205 may be provided with month, day of the month, as well as the day of the week as depicted in FIG. 2A. However, it should be appreciated that event date 205 may include other combinations of date information without departing from the present disclosure. It also should be appreciated that event date 205 may be depicted as a calendar wherein a user may select a preferred date, or as a text box wherein a user may enter a specific date for purchase. These options may be provided on the widget such as when a concert or event may be occurring in a city over the course of several days. In another example, the widget may provide the user with a calendar to select any date to visit a venue, such as zoo, when it is open for business. In a further example, if a user seeks to purchase airline tickets, a calendar may provided to show the user when airline tickets may be available for travel between certain cities, such as at a specified price and/or on specified dates.

The front view of widget 160 also may include provider icon 206 that may be linked to a website for the provider of widget 160. While only one provider icon has been provided in widget 160 of FIG. 2A, it should be appreciated that more than one provider icon may be included without departing from the present disclosure. For example, an icon for a promoter of the particular event also may be provided.

Other information that may be provided on the front view of widget 160 may include pricing information 207. Pricing information 207 may include the base price to purchase a package or tickets to an event or to make purchases of commerce, such as concert merchandise, according to embodiments of the present disclosure. Pricing information 207 also may include information such as whether there are any taxes or shipping costs that a user may incur by making the purchase. For example, pricing information 207 identifies that the price includes VAT but excludes shipping. Selection button 208 may be provided on the front view of widget 160 to allow a user to add an event, package, or other commerce to his/her purchase cart for later checkout and purchase.

The front view of widget 160 also may include share button 209 that may allow a user to share through social media platforms, such as Facebook or Twitter, the fact that he/she is considering making a purchase of the package or event. This may encourage the user's friends or family to make similar purchases so that they may join the user at a particular event. It also may encourage friends or family living in other geographical areas to consider purchasing tickets to similar events occurring where they live. In other embodiments of the present disclosure, use of share button 209 may drive interest in a particular artist, tour, package or even particular commerce in that friends and family may be talking about the user's purchase on these social media platforms. Widget 160 also may include a hyperlink to privacy policy 210 so that a user may select the link and understand the scope of the privacy policy with respect to usage of widget 160.

It should be appreciated that while the various components of widget 160 may be depicted as having a certain arrangement in FIG. 2A, the components may be arranged in different configurations without departing from the present disclosure. Further, more or fewer components may be included on the front view of widget 160 without departing from the present disclosure. In addition, while widget 160 may be depicted as being directed to a concert by a musician, it should be appreciated that a user may purchase tickets for events or activities other than concerts or purchase merchandise and other commerce using widget 160 without departing from the present disclosure as will be discussed in more detail below.

FIG. 2B depicts a back view of widget 160 according to an embodiment of the present disclosure. Widget 160 may include progress indicator 301 that may indicate the steps of the process that a user may engage in using widget 160 according to an embodiment of the present disclosure. In an embodiment of the present disclosure, indicator 301a may indicate that user has selected an item, such as concert tickets, to place in his/her cart for purchase. Such a selection may have occurred on the front view of widget 160 (FIG. 2A) when the user selected selection button 208 and placed an item in his/her cart for later purchase. Indicator 301b then may indicate that once an item has been selected for the cart (301a), the user may elect to pay for the item through one of several payment platforms, such as PayPal. In indicator 301c, the user may be provided with an indication that purchase of the item is completed (FIG. 2C). It should be appreciated that progress indicator 301 may include more or less than three steps in the process without departing from the present disclosure. Further, while progress indicator 301 is depicted as a top banner on the back view of widget 160, it should be appreciated that progress indicator 301 may be positioned in different areas on widget 160 without departing from the present disclosure. Further, it should be appreciated that, while progress indicator 301 is depicted on the back view of widget 160, progress indicator 301 also may be included on the front view of widget 160 without departing from the present disclosure. Widget 160 also may include back button 302 that may allow a user to return to the front view of widget 160, for example, if the user wishes to change his/her selection (i.e., select a different artist or package, or a different date to attend an event).

In an embodiment of the present disclosure, widget 160 may indicate image 304 that provides a depiction of the artist, concert or event selected by a user for purchase. Image 304 may be depicted in various file formats, including but not necessarily limited to, jpg, png and gif. While image 304 may be a static image, it should be appreciated that image 304 may be rotated or zoomed without departing from the present disclosure. It also should be appreciated that generally image 304 may be the same as image 201 depicted on the front view of widget 160 (FIG. 2A); however, there may be embodiments of the present disclosure where image 304 may differ from image 201 depicted on the front view of widget 160. It may be further appreciated that there may be some embodiments where no image may be appear on the back view of widget 160.

The back view of widget 160 may include event date 303 that may include similar information as event date 205 (FIG. 2A) and may be configured with different date information as previously discussed with respect to event date 205. Widget 160 also may include default widget name 306. Widget name 306 may include a sub-title such as event/venue location 307. It should be appreciated that event date 303, widget name 306 as well as event location 307 may be derived from custom JSON data fields without departing from the present disclosure. However, other types of data fields may be used on the back view of widget 160 without departing from the present disclosure.

In an embodiment of the present disclosure, widget 160 also may include map 305 that a user may select in order to choose his/her seat, for example, at a concert venue. If map 305 is incorporated as part of the back view of widget 160, upon clicking on map 305, the user may be provided with an enlarged version of a map of the venue where the event may be taking place. The user may then be presented with options to select a specific seat or groups of seats. The seat selection options may be configured to correspond with the number of tickets that a user may select with ticket selector 308. For example, if a user selects 4 tickets, then map 305 may provide the user with all of the seats that are available within the user's selected price range. In other embodiments of the present disclosure, the user may be presented with seat options outside of his/her selected price range in order to encourage an up sell (i.e., the user may be influenced to purchase tickets at a higher price than originally selected). If the user selects seats on map 305 within a higher price range than originally selected, type selector 308b may be modified upon making that selection. However, it should be appreciated that a user may elect not to select a particular seat on the map, such as when reserved seating may result in an added purchase cost. In other embodiments of the present disclosure, a user may not be presented with a map to select seats, such as when the event is only general admission or standing room only, or if unreserved seating may be all that is available for an event.

In an embodiment of the present disclosure, if a user is purchasing concert tickets, a user may be presented with an option to select tickets, such as through ticket selector 308. Ticket selector 308 may include several components, such as number selector 308a and type selector 308b. In some embodiments of the present disclosure, a user may also be presented with an option to select packages through package selector 309. Package selector 309 may include two components: number selector 309a and type selector 309b. It should be appreciated that ticket selector 308 and package selector 309 may each include more or less than two components without departing from the present disclosure. It may be further appreciated that the various components within ticket selector 308 and package selector 309 may provide a user with the option to utilize dropdown menu selections that may be derived from custom JSON data fields. Such dropdown menu selections may provide the user with a finite number of options, such as a finite number of tickets that may be purchased because there may be some embodiments where a user may only be permitted to purchase a maximum number of tickets or packages. It also should be appreciated that a user may only be provided with an option to select a certain number of tickets or packages because that is all that may be available for the event. Number selector 308a and number selector 309a may be depicted as static lists from 1-n wherein “n” is configurable by a custom data field. In some embodiments of the present disclosure, once a value has been selected, the package quantity selection may be set back to zero. In type selector 308b and package selector 309b, a user may be presented with pricing information associated with a particular ticket or package. For example, a ticket within a certain section at the venue may be assigned a particular price. Similarly, different package levels may be assigned different pricing. In some embodiments of the present disclosure, pricing may change dynamically; however, such changes may be pushed to the API by updating widget 160.

Widget 160 also may include delivery method 315 wherein a user may select how he/she wishes to receive the tickets or package to be purchased. In some embodiments of the present disclosure, a user may be presented with multiple options in delivery method 315, such as pick-up on-site, electronic delivery (such as via email download), or via various forms of mail (including but not limited to UPS, Federal Express or regular U.S. mail). In other embodiments of the present disclosure, the user may be presented with limited options under delivery method 315, such as when the user makes a purchase too close to the time that the event is scheduled to occur and would not be able to receive the tickets via mail. Similarly, options under delivery method 315 may be restricted by the venue or the provider, such as when the venue may not have service capacity to mail tickets and may require that a user either pick tickets up on-site or complete an electronic download.

In some embodiments of the present disclosure, the user may be provided with convenience charge information 317 that may indicate any convenience charges that may be (or have been) applied to the cost of the ticket or package to be purchased. These convenience charges may be taken from a custom JSON data field in an embodiment of the present disclosure. Inclusion of convenience charges on the back view of widget 160 may not change any charged prices; it may only present additional information for the buyer. A convenience charge may be depicted as “price reflect $X.XX convenience charge” wherein the amount may equal configured convenience charge multiplied by the selected quantity of tickets or packages. It should be appreciated that the convenience charge may not be used in the widget's price calculation according to some embodiments of the present disclosure.

Other information that may be provided on the back view of widget 160 may include pricing information 311. This pricing information 311 may include a total price that would be due based on the options that a user may have selected in ticket selector 308 and package selector 309. Pricing information 311 may include the base price as well as whether there are any taxes or shipping costs that a user may incur by making the purchase.

The back view of widget 160 may include information about a user's payment options if he/she elects to make a purchase. Icons that depict different credit card options and/or PayPal or other online payment options may be included as part of payment options 313. However, payment options may be depicted through text or other icons without departing from the present disclosure. Further embodiments of the present disclosure may provide for proprietary payment options, such as mobile carrier billing. This may be a helpful option for some users insofar as there are some countries around the world where residents may not prefer to utilize credit cards in online transactions or otherwise. In embodiments of the present disclosure, such a user may be provided with an option to enter his/her mobile telephone number through widget 160 in order to establish payment for tickets, and then the user's mobile telephone carrier may bill the user for the purchase at a later time.

Before a user selects checkout button 312 to make a purchase, a user also may be asked to affirm that he/she accepts the privacy policy and other terms and conditions for using widget 160 through privacy checkbox 314. It also should be appreciated that widget 160 may be configured such that a user may have to select at least a quantity of tickets with number selector 308a in order to select checkout button 312. In some embodiments of the present disclosure, if a user fails to select a quantity of tickets or fails to accept the privacy policy, the widget may return an error overlay. In other embodiments of the present disclosure, an error overlay may occur upon selection of checkout button 312, for example, when the quantity of tickets requested is no longer available or if the payment method fails, either due to user error or errors on the payment side.

In terms of ticket or event availability, several options may be made available to a ticket provider and/or widget provider. In some embodiments of the present disclosure, ticket availability may not be considered when showing the ticket or package quantity dropdowns, such as selectors 308a and 309a. Accordingly, availability may be checked at checkout only, such as once a user selects checkout button 312. In other embodiments of the present disclosure, availabilities for all of the options may be fetched during widget initialization and information about availabilities may be cached for a period of time while still keeping the loading time for most users acceptably low. In a further embodiment of the present disclosure, the widget options may be updated to inform the API whenever changes in ticket or package availability may occur.

Privacy policy 316 may be included as hyperlinked text on widget 160 in order to allow a user to view the privacy policy before selecting privacy checkbox 314. In other embodiments of the present disclosure, it should be appreciated that the text included with privacy checkbox 314 may be hyperlinked to allow the user to view the privacy policy or terms and conditions before selecting checkbox 314 without departing from the present disclosure. Further, as on the front view of widget 160, the back view of widget 160 may also include one or more of provider icon 310 that may be linked to a website for a provider.

When a user selects checkout button 312, an API call may be made to reserve the requested tickets according to an embodiment of the present disclosure. It should be appreciated that there may be requirements as to how long a reservation may be held by the system in order to safely avoid overbooking scenarios, such as with PayPal transaction expiration times. However, in other embodiments of the present disclosure, the system may limit the time that a reservation is held, such as when the system is to be held responsible for the risk of overbooking. In an embodiment of the present disclosure, if a user pays via PayPal, PayPal may issue an instant payment notification and the API may be called to confirm the reservation. The notification may then be matched with the user's reservation based on a unique identifier that may be generated when the system makes the API call to reserve tickets.

Embodiments of the present disclosure may provide for unique nightly client deposits wherein unique merchant accounts may be established for each customer. Accordingly, a provider of the widget may sell tickets for a merchant by the merchant signing up for the widget. Then, each day, the provider may deposit money associated with the sale of any tickets into the merchant account. It should be appreciated that other periods of time may be specified for such deposit without departing from the present disclosure. This is a departure from how other sales providers have handled insofar as it gets sales proceeds to the merchant faster and in a more accurate manner.

FIG. 2C depicts another view of widget 160 according to an embodiment of the present disclosure. A user may receive notification through widget 160 that his/her purchase has been completed. Accordingly, widget 160 may include notification 401 that may confirm completion of the purchase and may also inform a user that he/she may receive a further confirmation, such as through e-mail, of the purchase details. It should be appreciated that the further confirmation may not be provided directly from the provider of widget 160 as the system provider may be different from the ticket seller, and the purchase details may only be in the hands of the ticket seller. However, it should be appreciated that there may be embodiments of the present disclosure where the provider of widget 160 may have the purchase details and may provide them directly to the user.

Widget 160 also may include share indicator 402 (similar to share indicator 209 in FIG. 2A) that may allow a user to tell his/her friends about the purchase just made using widget 160. Share indicator 402 may include buttons for a user to access various social media platforms, such as Facebook or Twitter, to inform friends that he/she has purchased tickets to a concert or other event. Providing a user with share indicator 402 at the completion of his/her purchase through widget 160 may provide the user with an immediate means to encourage friends to also purchase tickets to a given event. This may be helpful for the provider of widget 160 as this may have a tendency to drive further ticket sales.

Widget 160 may also include close button 403 that may provide a user with means to close widget 160 upon review of notification 401 or after using share indicator 402. Embodiments of the present disclosure also may provide for inclusion of privacy policy 404 wherein a hyperlink may be provided for a user to reference the privacy policy at the conclusion of his/her purchase using widget 160. Further, provider icon 405 may be provided as a hyperlink to the website of the provider of widget 160 if a user wishes to find out additional information about the provider in embodiments of the present disclosure.

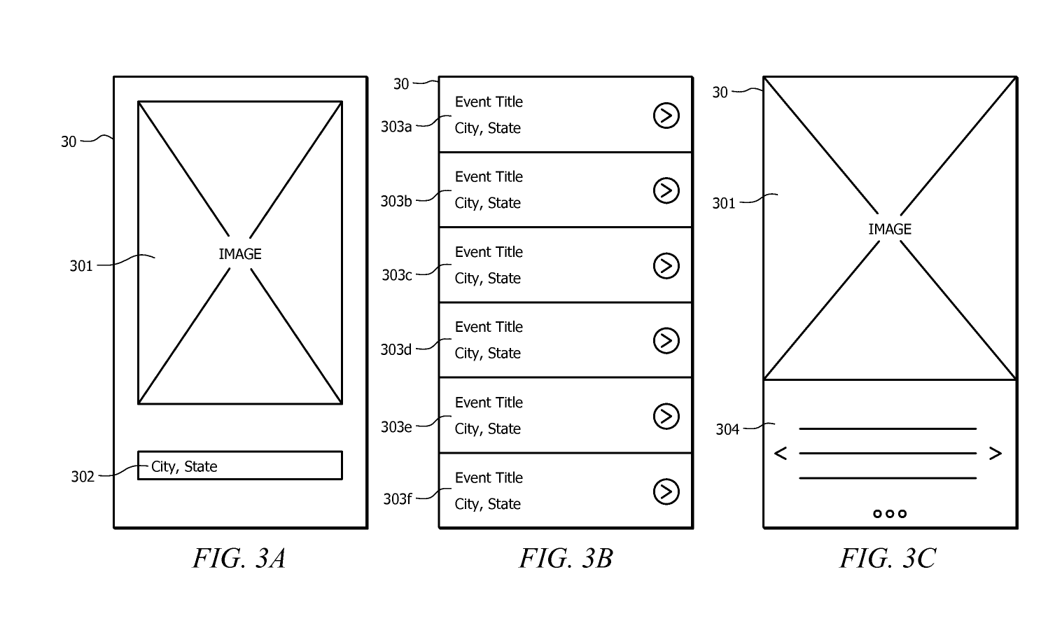

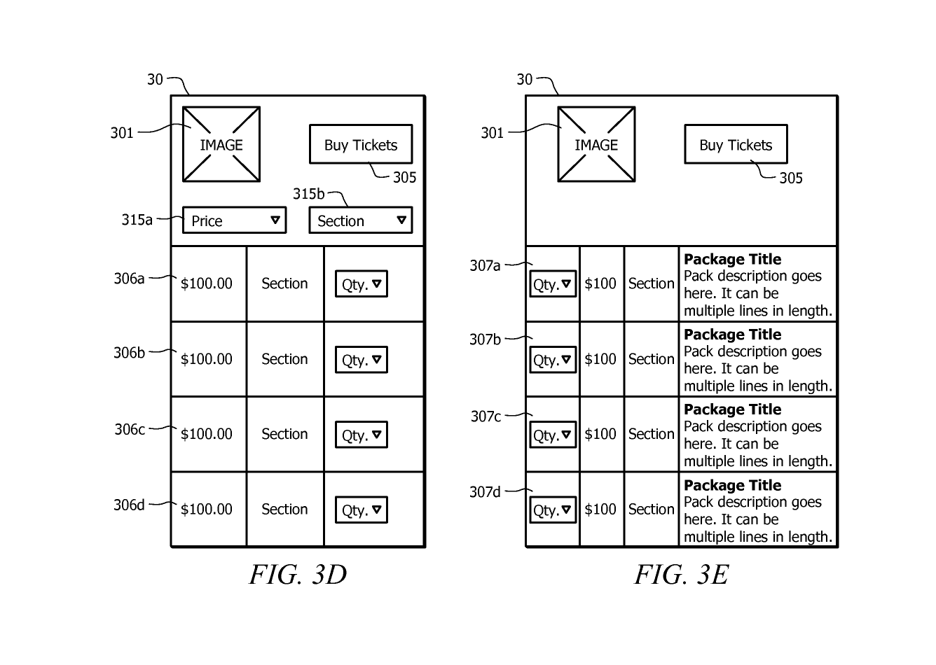

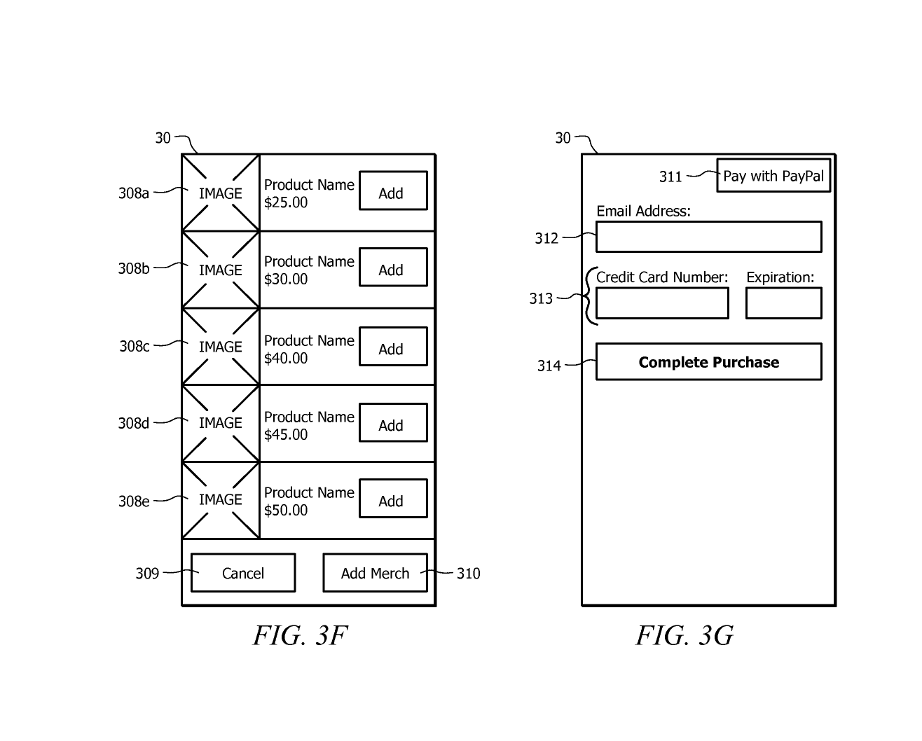

FIGS. 3A-3G depict other views of widgets that may be used to integrate geolocated sales with social media platforms according to embodiments of the present disclosure.

FIG. 3A depicts a view of widget 30 that may include image 301 as well as location 302 according to an embodiment of the present disclosure. Image 301 may provide a depiction of the artist, concert or event associated with the page where the user is on a social media platform. For example, if a user is on the Willie Nelson Facebook page, image 301 may be a picture of Willie Nelson or something associated with Willie Nelson or his tour, such as album art or a logo associated with the tour. Image 301 may be depicted in various file formats, including but not limited to, jpg, png and gif. While image 301 may be a static image, it should be appreciated that image 301 may be rotated or zoomed without departing from the present disclosure. Location 302 may be a text box that may include city and state information that may be pre-populated for a user based on a user's current location determined, for example, based on geolocating through the social media platform or from a user's IP address or mobile GPS location as previously described.

FIG. 3B depicts another view of widget 30 according to an embodiment of the present disclosure. In this embodiment, widget 30 may include first event 303a, second event 303b, third event 303c, fourth event 303d, fifth event 303e and sixth event 303f so that a user may be provided with several event options from which to select tickets. It should be appreciated that more or fewer events may be included on widget 30 without departing from the present disclosure. Events 303a-f may provide a user with information including, but not limited to, event title and city and state information. For example, if a user resides in Dallas, Tex., and Willie Nelson will be performing in Dallas as well as in Fort Worth (which is less than one hour away from Dallas), the user may be presented with options to purchase tickets for either tour stop. Regardless which event (303a-f) a user selects, the user may be directed to a purchase screen on widget 30.

FIG. 3C depicts another view of widget 30 according to an embodiment of the present disclosure. Widget 30 may include image 301 as previously described with respect to FIG. 3A. However, widget 30 also may include event list 304 that may provide a user with various event options. Event list 304 may be slidable or scrollable such that a user may look at and select from various event options based on date or location.

FIG. 3D depicts a further view of widget 30 according to an embodiment of the present disclosure. Widget 30 may include image 301 as previously described; however, in this embodiment, image 301 may be a thumbnail image to accommodate inclusion of pricing and other purchase information on this screen of the widget. It also should be appreciated that the thumbnail image may be a different image than was depicted in previous views of widget 30 without departing from the present disclosure.

Widget 30 may further include price selector 315a and section selector 315b. Price selector 315a may comprise a dropdown menu that may provide a user with the different prices depending on the ticket option desired. Section selector 315b also may comprise a dropdown menu that may provide a user with information about ticket availability for various sections within a venue. While price selector 315a and section selector 315b have been described as comprising dropdown menus, it should be appreciated that other selection mechanisms may be incorporated without departing from the present disclosure. Further, if a venue does not provide various pricing and/or section options, such as, for example, if all seating for the venue is general admission at the same price point, then price selector 315a and section selector 315b may be omitted from widget 30 in embodiments of the present disclosure.

As depicted in FIG. 3D, widget 30 may also include option selectors 306a-d in an embodiment of the present disclosure. Option selectors 306a-d may provide information including, but not limited to, price, section and quantity. With respect to quantity, the user may be provided with an option to select, for example, the number of tickets that he/she would like for the given event or activity. While this quantity selection is depicted as a dropdown menu, it should be appreciated that other selection mechanisms may be used without departing from the present disclosure. Further, it should be appreciated that the quantity associated with a given price and/or section may change depending on the number of tickets or seats available at that price or within that section. While option selectors 306a-d are depicted in FIG. 3D, it should be appreciated that more or fewer option selectors may be included on widget 30 depending on the number of price or section options that may be available for a given event or activity.

It should be appreciated that price selector 315a and section selector 315b may update to display the price and the section options selected using option selectors 306a-d according to an embodiment of the present disclosure. Once the user has made his/her selections either through price selector 315a and section selector 315b or through option selectors 306a-d, the user may select purchase selector 305 when he/she is ready to make a purchase and wishes to submit his/her ticket selections. While purchase selector 305 is depicted as a button, it should be appreciated that other selection mechanisms may be incorporated without departing from the present disclosure.

FIG. 3E depicts widget 30 according to another embodiment of the present disclosure. Similar to widget 30 depicted in FIG. 3D, widget 30 in FIG. 3E also may include image 301 as well as purchase selector 305. Once the user has made his/her selections such as through package selectors 307a-d, the user may select purchase selector 305 when he/she is ready to make a purchase and wishes to submit his/her ticket selections. While purchase selector 305 is depicted as a button, it should be appreciated that other selection mechanisms may be incorporated without departing from the present disclosure.

In this embodiment of the present disclosure, widget 30 may include package selectors 307a-d if different package options may be made available for a given activity or event. Package selectors 307a-d may provide information including, but not limited to, price, section, quantity, and package type. Information about package type may include a title for the package as well as a description of the package that may provide a user with details about what he/she will receive depending on the package selected. For example, a user may have the option to select a first package that may provide event tickets as well as merchandise or a second package that may include event tickets and backstage passes. While package selectors 307a-d are depicted in FIG. 3E, it should be appreciated that more or fewer package selectors may be included on widget 30 depending on the number of package, price or section options that may be available for a given event or activity. Further, more or less information about the packages may be included as part of package selectors 307a-d without departing from the present disclosure.

FIG. 3F depicts another view of widget 30 according to an embodiment of the present disclosure. In this embodiment, widget 30 may provide a user with the option to select different merchandise add-ons through merchandise selectors 308a-e. For example, a user may be presented with options to add merchandise at varying price points, including but not limited to hats, t-shirts, programs, and digital downloads. Merchandise selectors 308a-e may provide a user with information, including but not limited to an image depicting the merchandise (such as an image of a hat or t-shirt), the product name, and pricing information. Merchandise selectors 308a-e also may each include an add button so that the selected merchandise may be added to the user's cart for later purchase. While merchandise selectors 308a-e are depicted in FIG. 3F, it should be appreciated that more or fewer merchandise selectors may be included on widget 30 depending on the number of merchandise options that may be available for a given event or activity. While merchandise selectors 308a-e may provided on widget 30 in connection with the purchase of tickets for an event or activity, it should be appreciated that merchandise may be purchased using merchandise selectors 308a-e without requiring purchase of any tickets or even later following an earlier ticket purchase. For example, a user may want to purchase a Willie Nelson tour-related t-shirt because he/she likes Willie Nelson but cannot purchase tickets to the show. In another example, a user may purchase tickets to a Willie Nelson show through widget 30. The user may have attended the show but not purchase a t-shirt while at the show. Accordingly, the user may later elect to use merchandise selectors 308a-e on widget 30 to purchase that t-shirt or even other merchandise that may have been specifically marketed for a given event or venue.

Widget 30 as depicted in FIG. 3F also may include cancel button 309 that may provide a user with the option to cancel any merchandise selections prior to being asked to confirm payment. Widget 30 may further include purchase selector 310 that a user may select to add any merchandise selections made through merchandise selectors 308a-e to his/her cart for purchase. While cancel button 309 and purchase selector 310 are depicted as buttons in FIG. 3F, it should be appreciated that other selection mechanisms may be substituted for these buttons without departing from the present disclosure.

FIG. 3G depicts another view of widget 30 according to an embodiment of the present disclosure. In this embodiment, a user may be presented with various payment options in order to complete his/her purchase of tickets and/or merchandise through widget 30. Widget 30 may include PayPal payment button 311 that a user may select if he/she opts to purchase through use of PayPal or other similar online payment options. If a user selects button 311, he/she may be directed to a PayPal purchase screen through a link according to embodiments of the present disclosure. In other embodiments of the present disclosure, a user may elect to pay via credit card and may enter credit card information, including credit card number and expiration date, in credit card box 313. Regardless which payment option may be selected, a user may be asked to enter his/her email address in box 312 so that a confirmation email may be sent to the user upon completion of the purchase by selecting completion selector 314. In other embodiments of the present disclosure, box 312 may be formatted in a manner so that a user may provide a mobile telephone number so that a text message may be sent to confirm purchase. It should be appreciated that the email address or phone number also may be used to notify a user if there have been any changes related to his/her purchase. For example, a user may be notified if a tour date has been canceled or if the purchased merchandise is on back-order or if there is a delay in shipping. Completion selector 314 may be selected when a user has filled in purchase-related information on widget 30. While completion selector 314 is depicted as a button, it should be appreciated that other selection mechanisms may be incorporated according to embodiments of the present disclosure. It also should be appreciated that a user may receive an error message or other notification upon selecting completion selector 314, for example, if the user has failed to enter payment information or an email address, according to embodiments of the present disclosure.

Widgets according to embodiments of the present disclosure may provide a user with various offers. For example, a user may be provided with the option of purchasing tickets and selecting seats through use of a real-time seat-map. This may enable a user to pick his/her seats in real-time at the time of ticket purchase as opposed to a “quick pick” option that some ticket sellers provide. This may provide the user with maximum flexibility through use of an embedded widget. A user may also be provided with the option to purchase merchandise associated with an event at the same time that he/she purchases tickets to the event. Merchandise may include but is not limited to live music downloads, CDs, DVDs, t-shirts, other clothing, as well as programs. In another embodiment of the present disclosure, a user may purchase tickets as well as digital downloads through use of a widget. Digital downloads may include but are not limited to audio, video, as well as ringtones that may be associated with an artist, event or even a venue. While several examples have been provided, it should be appreciated that other commerce may be sold or bundled together according to embodiments of the present disclosure.

While examples may have been provided describing use of systems and methods according to embodiments of the present disclosure in the context of purchasing concert or event tickets and/or packages, it should be appreciated that the systems and methods may be used in conjunction with any point of sale system that is based online, including but not limited to, zoos, museums, sporting events, city tours, and other venues or activities. Further, as previously described, widgets according to embodiments of the present disclosure may be used to sell articles of commerce that may not be related to tickets, such as merchandise or digital downloads. A provider may sell or offer any type of commerce through the widget without departing from the present disclosure.

In other embodiments of the present disclosure, a user may make reservations for planes, trains, restaurants, and/or hotels through a widget embedded within a social media website. For example, a user may “like” the Facebook page of an airline offering low-priced plane tickets. If the user is based in Dallas, Tex., the user may be notified through this Facebook page when low-priced airline tickets are available out of Dallas-Fort Worth International Airport or Dallas Love Field. Then, the user may elect to use a widget embedded in that Facebook page to hold or purchase tickets for a desired flight without ever having to leave the Facebook page. In addition, the user may be able to share with family and/or friends through Facebook that he/she purchased certain airline tickets in order to encourage similar purchases by those family or friends.

In another embodiment of the present disclosure, systems and methods according to embodiments of the present disclosure may be used with resorts, such as ski resorts, or cruise ships to help in sales of various activities or events associated with the resort or cruise. For example, a widget for a ski resort may provide a user with options to purchase lift tickets, rent ski equipment, reserve hotel rooms, make reservations for ski lessons, and/or buy food all through a widget made available on the ski resort's social media platform(s). In an embodiment of the present disclosure, a cruise operator may provide a widget on its social media platform(s) wherein a user may purchase cruise tickets, airline tickets, food/beverage packages, and/or excursion packages without departing from the present disclosure.

Widgets according to embodiments of the present disclosure may be embedded within or linked to any social media platform accessible through a web browser or mobile application and are unique in that a user may complete a purchase while remaining within the social media platform. While examples have been provided of widget integration with Facebook or Twitter, it should be appreciated that systems and methods according to embodiments of the present disclosure may be integrated with other companies or platforms, including but not necessarily limited to Google Plus, Spotify, iTunes, Rhapsody, Pinterest, and/or Windows Mobile, without departing from the present disclosure. Accordingly, a widget, such as widget 160 or widget 30, may be incorporated or embedded into one or more of these social media platforms. In such embodiments of the present disclosure, the social media platform may run advertisements in and around the embedded widget in order to drive sales of products or services that may or may not be related to what is being offered through the widget.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A computer-implemented method for integrating geolocated sales with a social media platform rendered in a web browser, the method comprising:
interacting with a tickets database through a first communication link to look up an event;
receiving a response over the first communication link from the tickets database providing the event;
providing the event to a widget embedded within the social media platform through a second communication link;
receiving a purchase request corresponding to the event over the second communication link;
sending a ticket reservation request to the tickets database over the first communication link; and
submitting an order to an orders database over a third communication link.

2. The method of claim 1 further comprising:
receiving a message indicating ticket reservation success or failure in response to sending the ticket reservation request.

3. The method of claim 1 further comprising:
receiving a message indicating order submission success or failure in response to submitting the order to the orders database.

4. The method of claim 3 further comprising:
transmitting an order confirmation to a customer upon receiving the message indicating order submission success or failure.

5. The method of claim 4 wherein the order confirmation is transmitted to the customer via email.

6. The method of claim 1 further comprising:
communicating a message to the widget indicating purchase success or failure upon receiving the message indicating order success or failure.

7. The method of claim 1 wherein the web browser comprises one of the following:
Internet Explorer, Firefox, Chrome, Safari and Safari Mobile.

8. The method of claim 1 wherein the first communication link, second communication link and the third communication link each comprise one of the following:
local area network (LANs), wide area network (WANs), wired Ethernet, wireless Ethernet, Internet, cellular connection, serial connection, parallel connection, and USB connection.

9. A widget embedded within a social media platform rendered in a web browser, the widget comprising:
a first section to display information about an event corresponding to a geographical location of a user of the social media platform wherein the widget is embedded;
a second section to provide purchase options and a checkout function associated with the event; and
a third section to provide confirmation of the purchase associated with the event.

10. The widget of claim 9, the first section, the second section, and third section comprising:
a sharing button wherein the user shares the purchase with other users of the social media platform.

11. The widget of claim 9, wherein information about the event corresponding to the geographical location comprises at least one of the following:
an image corresponding to the event, an event title, an event location, an event date, and pricing information.

12. The widget of claim 9, the widget further comprising a progress indicator, wherein the progress indicator is located on one or more of the first section, the second section, and the third section.

13. The widget of claim 9, the second section further comprising:
a map identifying seats available for the event.

14. The widget of claim 13, the second section further comprising:
a ticket selector, wherein the map provides seats corresponding to the number of tickets selected through the ticket selector.

15. The widget of claim 9, the second section further comprising:
a package selector having a number selector and a type selector.

16. The widget of claim 9, wherein the purchase options comprise:
payment options and delivery method.

17. A system for integrating geolocated sales with a social media platform through a widget embedded in the social media platform, the system comprising:
a web browser rendering the widget embedded in the social media platform; and
an application programming interface (API) in communication with the web browser to provide an event to the widget, receive a purchase request from the widget, and confirming a purchase to the widget,
wherein the event corresponds to the geographic location of a user using the social media platform.

18. The system of claim 17 further comprising:
a tickets database, wherein the API interacts with the tickets database to look up and receive the event to provide to the widget.

19. The system of claim 18 wherein the API interacts with the tickets database to make a ticket reservation request and receive a message indicating ticket reservation success or failure.

20. The system of claim 17 further comprising:
an orders database, wherein the API interacts with the orders database to submit an order associated with the event.
